(19) United States
(12) Patent Application Publication
(10) Pub. No.: US 2009/0047378 A1
(43) Pub. Date: Feb. 19, 2009

(54) NON MARINE OR NON ALGAL SOURCED OMEGA 3 FEED/FOOD SUPPLEMENT AND PROCESS FOR STABILIZING, ENHANCING THE CONVERSION EFFICIENCY, AND ENRICHMENT OF OMEGA 3 FATTY ACIDS IN LIVESTOCK/HUMANS AND PRODUCTS THEREFROM

(75) Inventor: James F. Stewart, Kitchener (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: ADJUVANTS PLUS INC., Kingsville, ON (CA)

(21) Appl. No.: 12/280,906

(22) PCT Filed: Feb. 28, 2007
(86) PCT No.: PCT/CA07/00308

§ 371 Date: Aug. 27, 2008

Related U.S. Application Data
(60) Provisional application No. 60/777,116, filed on Feb. 28, 2006.

(51) Int. Cl. A23K 1/00; A23K 1/14; A23K 1/10; A23L 1/30; A23D 7/00

(52) U.S. Cl. 426/2; 426/601; 426/608; 426/607

(57) ABSTRACT

A feed/food process and product that provides a stabilized feed/food supplement that enhances the conversion efficiency and levels of omega 3 essential fatty acids including docasahexaenoic acid (DHA), Docosapentanenoic acid (DPA) and eicosapentenoic acid (EPA) in livestock/human products therefrom e.g. poultry. Specifically, Chickens (var. Ross) are fed a stabilized form of non-marine, non algal source omega 3 fatty acids including DHA, EPA, DPA for 5 weeks during a total 6 week production period that results in conversion efficiencies and increased levels of omega 3 fatty acids including DHA, EPA, DPA in various cuts and parts of poultry meat (legs, breasts etc. with or without skin) that also results in improved production benefits in terms of weight gains, improved flavour, taste, tenderness and less stress in poultry during production/transporting and the production of feeds/food and or ingredients with reduced levels of contaminants e.g. heavy metals.

### FIELD OF INVENTION

The present invention relates to a feed/food supplement and process that provides for: (1) a stable feed/ food non marine sourced product of omega 3 fatty acids including DHA, EPA, DPA, in livestock or products thereof that in the case of poultry (as an example) in turn provides (2) Omega 3 conversion efficiencies (3) increased levels for various cuts of poultry meat and products thereof (legs, breasts, etc with and without skin and bone less or non boneless), (4) improved Omega 3/6 ratios in the order of 1:3 to 1:4 and reduced amounts of Arachidonic acid (ARA), (5) production benefits in terms of weight gains and reduced stress during production/transport and (6) improved flavour, taste, tenderness in various cuts of poultry meat and products thereof.

### BACKGROUND OF THE INVENTION

Essential fatty acids e.g. omega 3a's cannot be manufactured by animals including humans and are required in human nutrition. There are two groups of essential fatty acids, omega-3 fatty acids and omega-6 fatty acids. There have been mainly three natural sources of omega 3 essential fatty acids i.e. marine or algae that have provided docasahexaenoic acid (DHA), and eicosapentenoic acid (EPA), or certain plant species that have the omega 3 form of alpha linolenic acid (ALA). Docosapentanenoic acid (DPA) is a precursor to DHA/EPA and has only been found in some marine species of mammals e.g. seal oil; DPA is not present in fish, algal or plant species.

Omega-3 fatty acids in the form of DHA/EPA are found naturally in the oil of cold-water fish, such as mackerel, salmon, sardines, anchovies and tuna or from certain algal species. Most natural source of omega 3 polyunsaturated fatty acids in fish oil or meal is algae. DPA has been sourced from marine seal oil. Marine organisms have been the main source of DHA, EPA, DPA, however, these sources are tending to be limiting in terms of cost, supply, purity (marine sources often report high levels of heavy metals e.g. mercury and other contaminants (dioxins, chlorobenzenes, etc>).

The Omega 3 form of ALA has been extracted oil from plants, such as flaxseed, canola (rapeseed). Omega-6 essential fatty acids are found in both animal and plant material. Plant sources include unprocessed, unheated vegetable oils such as corn, sunflower seed, safflower, soy, sesame, and cottonseed oils. They are also found in plant materials such as evening primrose, black current seeds and gooseberry oils as well as in raw nuts and seeds, legumes and leafy greens. Omega-6 fatty acids include linoleic acid and its derivatives, such as arachidonic acid (ARA). There are also conjugated fatty acids such as conjugated linolenic acid (CLA). Most processed foods contain little or no amounts of Omega 3's in stable form and ratios of omega 3's to omega 6's range from 1:4 or more.

Plant sources of omega 3 in the form of ALA are known to convert slowly into DHA at rates of 0-14% depending on individuals and the ratio of Omega 3's to Omega 6's in the diet.

Omega-3 fatty acids in the form of DHA, EPA, DPA or conjugated forms of omega 6's e.g. CLA, are linked to a wide variety of beneficial health effects in documented intervention studies as essential constituents of cells, especially brain cells, nerve cells, retina, adrenal glands, and reproductive cells. Long chain omega-3 polyunsaturates (PUFAs) such as DHA/EPA/DPA have clinically proven health benefits for the heart, skin, and immune system and help regulate inflammatory diseases, attention deficit disorders and infant development. There are also a number of new studies underway that suggest benefits in preventing Alzheimer's, dementia, diabetes II and colorectal cancers.

Table A** Afflictions Associated with a Deficiency of Omega 3 Fatty Acids

Acne, AIDS, Allergies, Alzheimer's, Angina, Atherosclerosis, Arthritis, Autoimmunity, Behavioural disorders, Breast cancer, Breast Cysts, Breast pain, Cancer, Cystic Fibrosis, Dementia, Diabetes, Eczema, Heart Disease, High Blood Pressure, Hyperactivity, Infection, Immune Deficiencies, Inflammatory conditions, intestinal disorders, kidney disease, Learning disorders, Leukaemia, Lupus, Malnutrition, Menopause, Mental Illness, Metastasis, Multiple Sclerosis, Neurological disease, Obesity, Post Viral Fatigue, Psoriasis, Reyes Syndrome, Schizophrenia, Stroke, Vision Disorders. ** Reference: Medline Medical Data Base 1999: Review of 1757 peer reviewed articles (US National Medical Library).

Omega 3's in the form of ALA, DHA, EPA or DPA are highly susceptible to peroxidation and breakdown in excessive heat, light and or oxygen. The resulting lack of stability can cause rancidity, off-flavouring, and odors when used as ingredients or in livestock feeds and products there from. The ALA content of most whole seed flax varieties averages from 18-25% w/w; in the oil fraction of flax seed the ALA content can vary from 50-60% in most varieties. However, if the flax seed is ground and left exposed to light, heat (room temperature) and oxygen for 2-4 weeks, the ALA content can drop from 20% to less than 8% w//w and decline further after 4 months to nearly zero. Similar effects can occur with the ALA content of flax oil. Several technologies have been developed to stabilize the ALA and nutritive content of ground flax seed e.g. NutraSprout™, that is produced from dried sprouted flax with a stabilized ALA content of approximately 20% w/w.

Arachidonic acid (ARA), an omega 6 has been associated with promoting inflammation; ARA levels in poultry e.g. chicken, turkey meat is high and greatly contributes to the high Omega 6/3 ratio in poultry meat e.g. at levels of 16:1 to over 23:1. For this reason, eating too much poultry meat e.g. has been known to cause inflammatory side-effects in some people (headaches). Aspirin (acetylsalicylic acid) is known to act by inhibiting the enzyme cycloxygenase that produces inflammatory prostaglandins that can be the result of dying cells that release ARA. While a certain amount of ARA is essential for healthy cell membranes, too much ARA can also result in inflammatory side effects in animals/humans.

There have been a number of patents granted outlining the benefits from specific omega fatty acids present in food and/or supplements. Several patents have also been granted for the enrichment of foods that are normally low or deficient in omega 3/6 and PUFA's. For example, U.S. Pat. No. 5,932,257 (Wright et al.) relates to DHA being produced in cow's milk through the feeding of cold-water fish meal to cows, using a feather meal based feed supplement. U.S. Pat. No. 7,001,062 (Stewart) also provides a method for producing elevated levels of Omega 3's including DHA, EPA, DPA in livestock products e.g. cows milk using a marine based feed supplement i.e. fish meal (Menhadden meal). U.S. Pat. Nos. 4,911,944 and 5,290,573 also disclose the use of feed supplements containing fish meal combined with animal by-products e.g. feather meal, bone meal and the like. The use of marine sourced DHA/EPA e.g. cold water fish such as herring, menhaden in the form of fish meal can also result in inconsistent levels of DHA/EPA due to oxidation. A number of patents have also been granted for the elevation of omega-3 in eggs using flax meal or algae/DHA feed supplements in chickens.

Newer and alternate technologies are available for producing DHA, EPA or DPA enriched animal by-products e.g. U.S. Pat. No. 7,001,062 (Stewart), U.S. Pat. No. 5,932,257 (Wright et al.) and alternate DHA enrichment products, Barclay, et al U.S. Pat. No. 6,054,147 and Barclay, U.S. Pat. No. 5,985,348. However, these technologies when used per se to enrich livestock and or livestock products that are not cost effective, and do not have the conversion efficiencies for practical use in most livestock feeds e.g. poultry or for the production of highly enriched omega 3 (DHA, DPA, EPA) food products, or ingredients from livestock or that result in production efficiencies.

Patents have also been granted for the elevation of omega-3 in eggs using flax meal or algae/DHA feed supplements in chickens. Flax in the case of most livestock feeds also acts as a laxative and can be a feeding deterrent. While flax seed is an excellent source of alpha linolenic acid, i.e. in the order of 15-20 g/100 g w/w, whole flax seed passes through the body almost entirely unconverted; ground flax seed on the other hand can rapidly lose its alpha linolenic acid (ALA) content when exposed to light, heat and oxygen (such as might occur in livestock feeds) and does not store well in terms of linolenic acid (ALA) or nutritive content as ground flax seed or in oil form for use in livestock feeds.

To date, livestock feed/food supplements have been based in either ALA plant based omega 3 sources e.g. flax with ALA but without DHA, DPA, EPA content and or cold water marine fish meal/algal sources with DHA, DPA or EPA content. All such known flax and or marine/algal feeds/food supplements have not been able to enrich all livestock parts with elevated levels of DHA, EPA and DPA e.g. poultry white, and or dark meats. Moreover, any such enrichment of some livestock products has often results in off-flavouring of meat cuts if marine based sources of DHA or EPA have been used in livestock feeds.

In terms of algae (DHA fermented concentrates), some feed and food mixes are produced via genetic recombination or fermentation technology, which has limited consumer favour and cost effectiveness in most markets.

It has also been documented that many food products for example, whole milk, and processed dairy products, meats, etc. contain omega 3/6's ratios of 1:5 or higher. Most scientific data and the views of health experts including nutritionists suggest that the lower the total omega 6 value relative to the omega 3 value, the greater the health benefits associated with the food. North American diets in particular have been widely documented as having higher (less healthy) omega 6 (polysaturated fatty acids) vs. omega 3 polyunsaturated fatty acids. Omega 3/6 ratios above 1:7 are of particular concern and may contribute to heart disease, circular disorders, and other health problems.

It has been suggested that consumption of certain grasses or plants by livestock may enhance the total amount of omega-3 fatty acids found in milk, meat and processed by-products versus the amount of omega-3 fatty acids found in conventional livestock fed silage feeds. However, relatively high levels of omega-3 fatty acids, usually in the form of alpha linolenic acid usually results in relatively low levels of DHA/EPA in processed livestock and products due to the poor conversion rate of ALA's in plants and or the relatively high levels of DHA required from marine sources.

The conversion of ALA into DHA, EPA or DPA is dependent on the key enzyme delta-6-desaturase; this key enzyme can be significantly inhibited by a number of factors 1 5 in animals (including humans) including: (1) an overbalance of omega 6's relative to omega 3's (2) an overbalance of the omega 6 linoleic acid (3) an abundance of insulin or predisposition to diabetes in animals/humans or (4) a decrease in delta-6-desaturase due to aging.

There is a need in the art for feeds/food supplements that act can synergistically to complement the total amount of DHA/EPA/DPA being converted or absorbed from the plants or non marine sources into the animal and processed livestock products relative to other fatty acids such as omega-6 fatty acids.

The present invention overcomes drawbacks in the prior art. The drawbacks are overcome by a combination of the features of the main claims. The sub-claims disclose further advantageous embodiments of the invention and may also overcome drawbacks in the prior art. The present invention provides for many of the key feature/benefits the marketplace is seeking e.g.: (1) A stable feed/ food non marine or non algal sourced product of omega 3 fatty acids including DHA, EPA, DPA, ALA that in turn provides in livestock e.g. poultry (2) Omega 3 conversion efficiencies via suitable Omega 3/6 feed/food ratios (3) increased levels for various cuts of poultry meat and products thereof (legs, breasts, (leaner cuts meat or other portions) etc with and without skin and bone less or non boneless), (4) improved Omega 3/6 ratios in processed livestock e.g. poultry, in the order of 1:3 to 1:4 and reduced amounts of Arachidonic acid (ARA), (5) production benefits in terms of weight gains and reduced stress during production/transport and (6) improved flavour, taste, tenderness in various cuts of poultry meat and products thereof, (7) non marine or non algal sources of omega 3 fatty acids ( DHA, EPA, DPA and ALA) that result in reduced levels of contaminants e.g. heavy metals.

There is strong market interest to produce elevated levels of DHA, EPA, DPA and total omega 3 fatty acids in various livestock products e.g. lean or various cuts of poultry meat and product thereof, although there have been several patents that have claimed elevated levels of omega 3 fatty acids e.g. Barclay et al, U.S. Pat. No. 6,054,147, these methods have not used non-marine sources of DHA/EPA/DPA and the feeding efficiencies for DHA levels in poultry diets were at 0.09% to 0.45% of the diet.

In addition, there currently exists no consistent method for elevating amounts of total omega 3 including DHA, EPA, DPA in various cuts including leaner cuts of poultry or livestock meat (with skin on or skinless) or methods to reduce omega 6 fatty acids that could be the cause of inflammatory disorders e.g. ARA or result in improved conversion efficiencies of DHA, EPA or DPA in livestock and processed livestock products.

Moreover, marine based products such as fish meal are banned in certain parts of the world as feed/protein sources for feeding livestock e.g. Europe. This invention would overcome the problem of how to enrich livestock and or products therefrom with DHA, EPA, DPA and or ALA.

These methods based on marine, fermentation and or algal omega 3 sources have not proved to be cost efficient, or have provided improved production benefits or to have conversion efficiencies of omega 3 fatty acids into livestock products e.g. poultry meat.

### SUMMARY OF THE INVENTION

The present invention provides for a novel, inventive and applicable product and process that teaches something new and provides for stable non-oxidized forms of omega 3 fatty acids from non-marine, non algal sources, forms of DHA, EPA, DPA. The invention provides for the stability of DHA, EPA, DPA and ALA omega 3 fatty acids and improves the conversion of Omega 3 fatty acids in a feed/food supplement to higher levels in livestock and products thereof particularly in leaner cuts of meat and other portions e.g. poultry meat.

When the stable omega 3 enriched feed/food product is fed to livestock such as poultry i.e. chickens, the invention provides (1) a stable feed/ food non marine, non algal sourced product of omega 3 fatty acids including DHA, EPA, DPA, and ALA that in turn provides in poultry (2) improved Omega 3 conversion efficiencies (3) increased levels for various cuts of poultry meat and products thereof (legs, breasts, etc with and without skin and bone less or non boneless), (4) improved Omega 3/6 ratios in the order of 1:3 and reduced amounts of Arachidonic acid (ARA), (5) production benefits in terms of weight gains and reduced stress during production/transport and (6) improved flavour, taste, tenderness in various cuts of poultry meat and products thereof and (7) non marine or non algal sources of omega 3 fatty acids ( DHA, EPA, DPA and ALA) that result in reduced levels of contaminants e.g. heavy metals.

We contemplate a food/feed supplement comprising, when using an oil, from 0.1% to 80% w/w of non-marine DHA, EPA, DPA and ALA, when each acid is taken separately or together, preferably from 1% to 60 or 75% w/w, especially 5 or 10% to 50% w/w, more particularly 18% to 30%, e.g. 18% to 25% w/w. When using seed, the amounts of non-marine DHA, EPA, DPA and ALA are contemplated to be in the range of 0.1% to 30% w/w, particularly 2% to 25% w/w, more particularly 2.5 or 5% to 25% w/w, especially 5% to 20% w/w, e.g. 5% to 10 or 15% w/w.

We also contemplate omega 3/6 fatty acid ratios of 1:1 or 1:2 to 1:6, preferably, 1:3 to 1:5, particularly 1:3 to 1:4.

We also contemplate that the food/feed supplement comprise 1-10% w/w of a final food mix, preferably 2% to 8% w/w, especially 3 or 4% to 6% w/w, particularly 5% w/w.

Preferably, the livestock e.g. in this instance chickens (Var. Ross), are fed a stabilized omega 3 sourced diet for a 5 week normal production period in which the omega 3 feed/ food supplement could comprise any level of chosen DHA, EPA, DPA, ALA enrichment, but in an example, the total level of DHA, EPA, DPA consists of 0.00001% w/w of combined DHA, EPA, DPA of the total diet fed to chickens. Total amount of stabilized ALA from plant sources as a result of this invention e.g. flax, is at 5% w/w or less.

Thus, in an example, a sample of the omega 3 stabilized feed/food supplement would contain 5.18% of total ALA, DPA, EPA, and DPA w/w in the chicken diet or 0.18% w/w DHA/EPA/DPA in the feed/food supplement or 0.00001% of the total feed diet. For comparison purposes e.g. the total amount of DPA, EPA from marine sources used as livestock feed supplements in patents by U.S. Pat. No. 7,001,062 (Stewart), U.S. Pat. No. 5,932,257 (Wright et al.) was of the order of 5.5% w/w or 1% w/w in total feed diet; the current invention provides for an order of 30 or more times less DHA, EPA than present (or required) in other livestock marine sourced livestock feeds to achieve higher levels of omega 3's than from other processes, thus making for improved cost and conversion efficiency. DPA in this instance is entirely novel as a stable non marine source, as DPA most often occurs in seal oil and other marine mammals.

### DETAILED DESCRIPTION OF THE INVENTION

As employed above and throughout this disclosure, the following items unless otherwise indicated shall be understood to have the following meaning: Alpha linolenic acid (“ALA”) is referred to as the main Omega 3 parent compound; while the main Omega-6 parent compounds is generally identified as linoleic acid (“LA”). Reference is made to the Omega 3 (essential fatty acids) docosahexaenoic acid (“DHA”), docosapentaenoic acid (“DPA”, eicosapentaenoic acid (“EPA”), and the conjugated linoleic acid (“CLA”) and omega 6 fatty acid arachidonic acid (“ARA).

Conversion efficiency refers to the level of Omega 3 conversion relative to the level of Omega 3's in the feed/food supplement; the feed/food supplement refers to the feed/food supplement prepared (as an example) and used to feed poultry (chickens) as an example in this invention.

Production period refers to a time period in livestock e.g. for poultry from hatching of poultry until its slaughter.

Poultry refers to any avian species that is used as food e.g. chickens, turkeys, Cornish hens, pheasants, quails, ducks, geese, pigeons, ostrich, emus, etc.

Omega-3 fatty acids are found naturally in the oil of cold-water fish, are referred to such as mackerel, salmon, sardines, anchovies and tuna, or as extracted ALA oil from plants, such as flaxseed, canola (rapeseed).

Flavour, taste, tenderness rating refers to a method of rating the flavour, taste, and tenderness by consumers using a given rating scale.

PUFA refers to polyunsaturated fatty acids; MUFA refers to monounsaturated unsaturated fatty acids.

The present invention provides for: (1) a stable feed/food non marine non algal sourced product of omega 3 fatty acids including DHA, EPA, DPA, that in turn provides for livestock and products thereof e.g. in poultry (2) Omega 3 conversion efficiencies (3) increased levels for various cuts of poultry meat and products thereof (legs, breasts, etc with and without skin and bone less or non boneless), (4) improved Omega 3/6 ratios in the order of 1:3 and reduced amounts of Arachidonic acid (ARA), (5) production benefits in terms of weight gains and reduced stress during production/transport and (6) improved flavour, taste, tenderness in various cuts of poultry meat and products thereof and (7) ) non marine or non algal sources of omega 3 fatty acids ( DHA, EPA, DPA and ALA) that result in reduced levels of contaminants e.g. heavy metals.

Specifically, the product and process can be described in six steps i.e.: (1) The preparation of a stable non-oxidized feed/food supplement containing a combination of plant sourced ALA (alpha linolenic acid) and non-marine sourced DHA, DPA and EPA (2) the feeding of the feed/food supplement to chickens (Var. Ross) at 5% w/w per kg of a total chicken diet (chicken starter feed) for a 5 week period (3) observing/measuring feed consumption per bird and over-all flock behaviour during production and transport to slaughter (4) measuring the total amount of omega 3 fatty acids ( including DHA, EPA, DPA) in various cuts of chicken meat ( with and without skin), ratios of omega 3/6 fatty acids and content of ARA fatty acid in various cuts of poultry meat and (6) conducting taste, flavour, quality and tenderness tests of chicken fed the feed/food supplement Vs those not fed the supplement.

### Preparation Of A Stable Feed/Food (Omegarich) Supplement

It is well documented that ALA, and related enzymes are rapidly oxidized when ground plants rich in ALA e.g. flax seed are ground and exposed to light, heat and oxygen, etc. for 24 hours or more e.g. in livestock feed/foods.

Whole food grade flax seed or ground (powdered) food grade sprouted flax seed e.g. NutraSprout™ was placed in a Warring blender (see Table 1 for components); stabilized non-marine oil produced from DHA/EPA/DPA enriched 80% fat oil product (several types of sources) was heated (35 to 45° C.) and was added to the Warring blender together with Canola oil (trans fat free or non trans fat free). The entire contents of the Warring blender were then blended for 2-3 minutes ensuring the mixing of all components; in the case where whole food grade flax seed was used, the blending is done for 4-5 minutes to ensure that the flax seed is ground (powdered) with the entire mix. The entire mix is allowed to sit for at least 2 hours at room temperature to ensure complete absorption and coating of all plant oils with the ground flax seed. The food/feed supplement product can then be incorporated into livestock feed preparations for use in livestock feed operations e.g. poultry or stored as a food/feed supplement product indefinitely at refrigerated temperatures (2-4° C.) prior to use. The amount of ALA plant source material, DHA/EPA/DPA non marine source material and ALA plant sourced oil e.g. Canola oil quantities can vary depending on the desired omega 3 fatty acid level of the livestock feed/food supplement.

TABLE 1
Components of feed/food Supplement (Example)

| | w/w |
|---|---|
| NutraSprout (dried sprouted flax) or ground whole food grade | 250 g |
| flax: | |
| DHA/EPA/DPA non marine oil source (80% fat or various fat | 460 g |
| levels): | |
| Canola Oil (and or ALA food grade plant oil source (transfat | 290 g |
| free)): | |
| Total: | 1000 g |

### The Feeding Of The Livestock ( Omegarich )Food/Feed Supplement To Poultry, Stability Of Feed/Food Supplement, Slaughter Of Chickens, And Omega 3 Enrichment Analysis

The food/feed supplement was mixed/blended with chicken starter feed at a rate of 5% w/w per kg of chicken feed (See Table 2) to 100 chickens in the treated group. The untreated (control) group of 100 chickens was fed only the chicken feed. Both groups were fed the chick starter for 14 days prior to beginning the feeding trials.

TABLE 2
(Chicken feed) Fed to all chicks 14 days or older
Ingredients - corn, soy, wheat.

| | |
|---|---|
| Crude Protein | 17.5% |
| Crude Fat | 3.0% |
| Crude Fiber | 3.5% |
| Calcium | 0.81% |
| Phosphorous | 0.71% |
| Sodium | 0.18% |
| Vitamin A | 9,000 IU/kg |
| Vitamin D | 2,750 IU/kg |
| Vitamin E | 20 IU/kg |

Feed contains added selenium at a level of 0.3 mg/kg
Feed from 21 days old to 49 days of age

Prior to using the above feed, the chickens were fed for 14 days as chicks on chicken starter (see Table 3)

### Chick Starter:

TABLE 3
This feed contains added selenium at a level of 0.3 mg/kg.
Medicated with 0.0125% amprolium as an aid in the
prevention of deaths from coccidiosis.

| | |
|---|---|
| Protein | 20% |
| Crude Fat | 3% |
| Crude Fiber | 3% |
| Calcium | 1% |
| Phosphorous | 0.76% |
| Sodium | 0.17% |
| Vitamin A | 11,000 IU/kg |
| Vitamin D | 3,000 IU/kg |
| Vitamin E | 40 IU/kg |

Feed from 1 to 21 days.

### EXAMPLE 1

### The Omega 3 Stability Of The (Omegarich) Food/Feed Supplement

The food/feed supplement was stored ( exposed to light/heat) at room temperature for 14 days and measured for total omega 3′ fatty acids including DHA, EPA, DPA levels (mg/100g) ( see Table 4); the use of whole (ground) flax* or ground dried sprouted (NutraSprout) flax did not affect total ALA or DHA, EPA, DPA content. A total of 3 food/feed supplement mixes were prepared and stored for 14 days (room temperature) and analyzed for total Omega 3 content (see Table 4 below).

*food grade flax seed

TABLE 4
Omega 3 Content mg/100 g after 14 days
(Average of 3 samples)

| Ground Flax | NutraSprout Flax | Supplement | Supplement |
|---|---|---|---|
| Seed | (Stabilized) | with NutraSprout | with ground flax |
| ALA 5 g/100 g | ALA 20 g/100 g | ALA 5.0 g; | ALA5.0 g; |
| | | DHA74 mg; | DHA74 mg |
| | | EPA 42.3 mg; | EPA 43 mg; |
| | | DPA 60 mg | DPA 61 mg |
| Total Omega 3 | | | |
| 5 g/100 g | 20 g/100 g | 5.177 g/100 g | 5.178 g/100 g |

*LA (alpha linolenic acid)

Table 4 illustrates the Omega 3 content and stability of a feed/food non marine sourced product of omega 3 fatty acids including DHA, EPA, and DPA. NutraSprout is a stable ALA product of dried sprouted flax seed. The feed/food Supplement remained stable in terms of ALA, DHA, EPA and DPA content if either stabilized NutraSprout or ground flax seed was used. This, in spite of a 75% loss in ALA content when ground flax is left to oxidize for 14 days at room temperature. No oxidation or loss of omega 3 content in the feed/food supplement was recorded over 14 days when samples were exposed to light, heat at room temperature (20° C.) or ambient air temperature.

### Example 2

### Increased Omega 3 Levels And Conversion Rates For Various Types Of Chicken Meat

This example illustrates the Omega 3 increased levels and conversion efficiencies for various cuts of poultry meat and products thereof (legs, breasts, etc with and without skin and bone less or non boneless) fed the feed/food Supplement for 5 weeks.

Various types of chicken meat cuts were sampled and analyzed for total fat and total omega 3/6 fatty acid content (see Table 5)

TABLE 5
Levels of Omega 3 Fatty Acids in Various Cuts of Chicken Meat from
Chickens Fed Feed/Food Supplement (Table 1) at a rate of 50 g/1000 g of total Chicken
Feed for 5 Weeks (Legs were with skin; breasts were without skin).
Average Omega 3/6 content mg/100 g samples of Chicken meat Untreated and Treated.

| | | | Treated | Treated | Treated | Treated |
|---|---|---|---|---|---|---|
| | Untreated | Untreated | Breasts | Breasts | Legs | Legs |
| | Legs | Breasts | Sample 1 | Sample 2 | Sample 1 | Sample 2 |
| ALA (C18:3n3) | 146.0 | 20.7 | 43.6 | 84.0 | 538.9 | 899.0 |
| ARA (C20:4n6) | 133.6 | 61.6 | 48.6 | 49.4 | 0 | 94.8 |
| DHA (C22:5n3) | 0 | 0 | 29.7 | 29.5 | 54.8 | 40.7 |
| EPA (C20:5n3) | 0 | 0 | 0 | 0 | 16.5 | 19.6 |
| DPA (C22:6n3) | 0 | 0 | 24.6 | 31.6 | 54.6 | 59.4 |
| Total Fat | 11992.2 | 1975.5 | 1241.4 | 2153.1 | 10921.8 | 18883.7 |
| Saturated Fat | 3503.3 | 623.1 | 369.6 | 641.2 | 2841.5 | 5085.3 |
| Trans Fat | 19.1 | 0 | 0 | 0 | 15.8 | 49.3 |
| MUFA | 5451.6 | 868.2 | 474.0 | 916.0 | 4792.9 | 8821.0 |
| PUFA | 2912.4 | 484.2 | 397.9 | 595.8 | 3160.3 | 4655.0 |
| Total DHA + EPA + | 0 | 0 | 54.3 | 61.1 | 125.9 | 119.7 |
| DPA | | | | | | |
| Total Omega 3 | 166.9 | 20.7 | 97.9 | 145.0 | 809.9 | 1018.7 |
| Total Omega 6 | 2745.5 | 463.5 | 300.0 | 450.8 | 2350.4 | 3653.3 |
| Omega 3/6 Ratio | 1:16 | 1:22 | 1:3 | 1:3 | 1:3 | 1:4 |
| Reduction | | | 21% | 20% | 100% | 29% |
| Of ARA | | | | | | |
| Over Untreated | | | | | | |
| Increase in | | | 373% | 600% | 385% | 510% |
| Total Omega 3's | | | | | | |
| Over Untreated | | | | | | |

### Conversion and Omega 3 Enrichment Efficiency Rates.

The feed/food supplement in the above examples was fed to chickens for 5 weeks at a rate of 50 g/kg of chicken feed. This resulted in a total omega 3 of 5.184% w/w or 51.77 g per 1000 g (1 kg) of chicken diet (feed).

The total DHA/EPA/DPA content of the feed/food supplement in above examples was 0.18% w/w or 1.77 g per 1000 g (1 kg). By comparison most marine source livestock omega 3 feed supplements have used total DHA/EPA levels of 5.5% w/w or some 30 times more DHA/EPA sourced product in feeds than used for the results in Table 5. The DHA/EPA/DPA enrichment levels of marine sourced DHA/EPA livestock feeds e.g. cows milk or beef has been in order of 20 mg/100 g (DHA/EPA/DPA).

The feed/food supplement although having approximately 30 times less DHA/EPA/DPA sourced ingredients as used in the above examples resulted in DHA/EPA/DPA levels of 58 to 123 mg/100 g or approximately 3 to 6 times higher levels than previous livestock feeds using marine sourced DHA/EPA. Total omega 3 levels in the above examples ranged from 121 to 914 mg/100 g Vs 30 to 50 mg/100 g for most marine based livestock diets or approximately 4-18 times higher levels for the non marine DHA/EPA/DPA sourced feed/food supplement.

### Example 3

### Omega 3/6 Ratios In Poultry Meat And Reduced Levels Of Ara

This example illustrates the improved Omega 3/6 ratios in the order of 1:3 to 1:4 and reduced amounts of Arachidonic acid (ARA). This is illustrated by the data in Table 5.

Table 5 shows the improved Omega 3/6 ratios in the order of 1:3 to 1:4 over untreated samples of ratios of 1:16 to 1:22 with increased total omega 3 fatty acids at levels of 373% to 510% depending on the type of poultry meat and reduced amounts of Arachidonic acid (ARA) by 20-29% on average.

### Example 4

### Dressed Weight Gains And Reduced Stress For Chickens

This example illustrates production benefits in terms of weight gains and reduced stress during production/transport for chickens

TABLE 6
Production weights of males/female dressed carcasses

| Randomized Average Dressed | |
|---|---|
| Weights of Chicken Carcasses (kg) | |
| Untreated | |
| (Controls) | Treated |

| | Males | Females | Males | Females |
|---|---|---|---|---|
| | 3.41 | 2.62 | 3.64 | 2.88 |
| | 3.39 | 3.14 | 4.18 | 2.88 |
| | 3.45 | 2.92 | 3.71 | 2.58 |
| | 3.40 | 2.66 | 3.74 | 2.93 |
| | 3.39 | 2.62 | 3.77 | 2.35 |
| | 3.41 | 2.66 | 3.74 | 3.17 |
| | 3.40 | 3.14 | 3.27 | 2.74 |
| | 3.44 | 2.91 | 3.80 | 2.88 |
| Average | 3.41 | 2.84 | 3.73 | 2.80 |

Average increase in male dressed weights of male treated chickens over controls was 0.32 kg or 9.4% net gain.
Average increase of treated chickens (males and females) over controls (untreated) 5%
** chicken carcasses of treated chickens appeared leaner and to have less fat than untreated birds.

TABLE 7
Reduced stress items during production and transport
Activity Levels of males/female chickens during production and Transport
Randomized Average Activity Levels (1-10)* at Weeks 3 and 5
And During Transport to Slaughter

| | Untreated | | | | | |
|---|---|---|---|---|---|---|
| | (Controls) | | | Treated | | |
| | Production | | Transport | Production | | Transport |
| | Males | Females | (Average) | Males | Females | (Average) |
| | 8.0 | 7.0 | 6.5 | 3.0 | 4.0 | 3.0 |
| | 7.0 | 9.0 | 5.5 | 4.0 | 3.0 | 3.0 |
| | 8.5 | 8.0 | 6.0 | 3.0 | 5.0 | 2.5 |
| | 9.0 | 9.0 | 5.0 | 3.0 | 4.0 | 2.0 |
| | 7.5 | 8.0 | 4.0 | 5.5 | 4.0 | 3.0 |
| | 6.5 | 8.0 | 5.5 | 5.0 | 3.0 | 3.0 |
| | 9.0 | 9.5 | 6.0 | 4.5 | 2.0 | 3.5 |
| | 7.0 | 8.5 | 7.0 | 4.0 | 3.0 | 4.0 |
| Average | 7.8 | 8.4 | 6.7 | 4.0 | 3.5 | 3.0 |

*Activity levels 1 = very quiet, little activity and 10 = very active, stressed movements; stress levels also measured by picking up birds and monitoring activity.

Treated birds were significantly less stress and had less activity levels than untreated chickens; the levels of activity levels were approximately 2× for untreated chickens during production; the same 2× less activity was also seen during transport to slaughter.

### Example 5

### Flavour, Taste And Tenderness Of Various Cuts Of Chicken Meat

This example illustrates improved flavour, taste, and tenderness in various cuts of poultry meat for treated and untreated chickens. Five people were asked to rate the various types of chicken meat samples (legs, breasts) for flavour, taste, and tenderness based on a scale of 1 to 10 in a blind test. All samples had been previously frozen for 10 days and then unthawed and cooked over a gas BBQ (no flavorings added). No other foods were prepared and all tasting was done for BBQ chicken only; no beverages.

TABLE 8
Flavour, Taste and tenderness ratings by taste panels (double blind
test). Flavour, Taste and Tenderness Rating in Various Cuts of
Chicken Meat from Chickens Fed Feed/Food Supplement (Table 1) at
a rate of 50 g/l000 g of total Chicken Feed for 5 Weeks (Legs were
with skin; breasts were without skin); samples had been
previously frozen for 10 days with bones intact.
Samples of various cuts of meat were chosen at random
from frozen stocks of untreated and treated meat.
Average of 5 cooked samples (Gas BBQ used) of Chicken meat
Untreated and Treated

| | | | Treated | Treated | Treated | Treated |
|---|---|---|---|---|---|---|
| | | Un- | Breasts | Breasts | Legs | Legs |
| | Untreated | treated | Sample | Sample | Sample | Sample |
| | Legs | Breasts | 1 | 2 | 1 | 2 |
| Consumer 1 | 5.0 | 4.5 | 2.5 | 2.0 | 1.5 | 2.0 |
| Consumer 2 | 4.0 | 3.0 | 3.0 | 2.0 | 2.0 | 2.0 |
| Consumer 3 | 5.5 | 4.5 | 4.0 | 3.0 | 2.0 | 1.5 |
| Consumer 4 | 6.5 | 6.0 | 4.5 | 4.0 | 3.5 | 3.5 |
| Consumer 5 | 4.5 | 5.5 | 2.0 | 1.5 | 1.5 | 2.0 |

** flavour, taste, tenderness ratings 1 = excellent and 10 = poor
average cooking times 20 minutes for unfrozen samples averaging 125 g in portion sizes.

Overall trend for flavour, taste and tenderness was that all treated samples received higher scores for all treated chicken (meat) samples Vs untreated samples. Treated samples also appeared to cook faster.

### References Cited In The Description

| U.S. Pat. No. 6,054,147 | Apr. 25, 2000 | Barclay et al. |
|---|---|---|
| U.S. Pat. No. 5,069,903 | Dec. 3, 1991 | Stitt, Paul, A |
| U.S. Pat. No. 6,103,276 | Aug. 15, 2000 | Pilgrim et al. |
| U.S. Pat. No. 5,932,257 | Aug. 3, 1999 | Wright et al. |
| U.S. Pat. No. 5.985,348 | Nov. 16,1999 | Barclay, William R. |
| U.S. Pat. No. 7,001,062 | Feb. 21, 2006 | Stewart, James F. |
| US patent application 2005 | Dec, 1, 2005 | Bartlett, Brian |
| 0266052 | | |

US patent application 2005 0266052 Dec. 1, 2005 Bartlett, Brian

1. A livestock or human feed/food supplement comprising a stable plant-derived and or livestock-sourced source of essential omega 3 fatty acids docasahexaenoic acid (DHA), eicosapentenoic acid (EPA), docosapentanenoic acid (DPA) or alpha linolenic acid (ALA) or an omega 6 fatty acid wherein the plant-derived source is a plant seed or plant seed oil.

2. The feed/food supplement of claim 1 wherein said plant seed is ground.

3. The feed/food supplements of claim 1 wherein said plant seed is sprouted and ground and or whole seed is ground.

4. The feed/food supplement of claim 1 comprising flax seed or plant-sourced alpha linolenic acid (ALA).

5. The feed/food supplement of claim 1 comprising a plant seed oil and or livestock-sourced product.

6. The feed/food supplement of claim 5 wherein said plant seed oil is Canola oil.

7. The feed/food supplement of claim 1 comprising DHA (docasahexaenoic acid), EPA (eicosapentenoic acid), DPA (docosapentanenoic acid) and ALA (alpha linolenic acid).

8. A human or animal foodstuff comprising the feed/food supplement of claim 1.

9. A process for providing enriched/elevated and improved efficiency levels of total omega 3 fatty acids in an animal or animal product which process comprises feeding said animal the feed/food supplement of claim 1 resulting in elevated levels of DHA, EPA, DPA in all animal or animal (livestock) parts independent of fat content.

10. The process of claim 9, wherein the ratio of omega 3 fatty acid to omega 6 fatty acid in the animal or animal product is in the range of 1:3 to 1:4.

11. The process of claim 9, wherein the level of ARA (arachidonic acid) is reduced in the animal or animal product.

12. A process for providing an improved essential omega 3 fatty acid conversion feed/food efficiency in livestock or a human or product therefrom in which the process comprises feeding said livestock or human the feed/food supplement of claim 1.

13. A process for proving providing improved poultry weight gain or reduced stress during production or transport which process comprises feeding poultry said feed/food supplement of claim 1.

14. A process for improving flavour, taste, color, or tenderness of a livestock product which process comprises feeding livestock said feed/food supplement of claim 1.

15. The process of claim 14 wherein said livestock product is poultry meat.

16. The process of claim 9 wherein the source of DHA, EPA, DPA is from re-cycled DHA, EPA, DPA (essential omega 3 fatty acid) sources that are non-marine, non-algal or non-microbial and such said re-cycled sources are livestock and or plants.

17. The process of claim 12, wherein the source of DHA, EPA, DPA is from recycled DHA, EPA, DPA (essential omega 3 fatty acid) sources that are non-marine, non-algal or non-microbial and such said re-cycled sources are livestock and or plants.

18. The process of claim 13, wherein the source of DHA, EPA, DPA is from recycled DHA, EPA, DPA (essential omega 3 fatty acid) sources that are non-marine, non-algal or non-microbial and such said re-cycled sources are livestock and or plants.

19. The process of claim 14, wherein the source of DHA, EPA, DPA is from recycled DHA, EPA, DPA (essential omega 3 fatty acid) sources that are non-marine, non-algal or non-microbial and such said re-cycled sources are livestock and or plants.
